(19) United States
(12) Patent Application Publication
(10) Pub. No.: US 2023/0272599 A1
(43) Pub. Date: Aug. 31, 2023

(54) WORK MACHINE SAFETY ZONE CONTROL

(71) Applicant: Caterpillar Inc., Peoria, IL (US)

(72) Inventor: Matthew J. BEHMLANDER, West Olive, MI (US)

(73) Assignee: Caterpillar Inc., Peoria, IL (US)

(21) Appl. No.: 17/683,297

(22) Filed: Feb. 28, 2022

(51) Int. Cl. E02F 9/24; E02F 9/20; E02F 9/26; G06V 10/74; G06V 10/82; G06V 10/56; G06V 40/10; G06V 20/56; G07C 3/08

(52) U.S. Cl. CPC E02F 9/24; E02F 9/2033; E02F 9/261; G06V 10/74; G06V 10/82; G06V 10/56; G06V 40/103; G06V 20/56; G07C 3/08; G06V 2201/07; H04W 4/44

(57) ABSTRACT

A work machine is disclosed. The work machine has a machine control for controlling the movements of the work machine in an operating mode of the machine control. The work machine also has a processing unit that has a detection unit. The detection unit is located on the work machine and is used to detect a target object within a safety zone. The processing unit sends a detection signal to the machine control when the target object is detected within the safety zone, and the machine control enters a safety mode from the operating mode when the detection signal is received. In the safety mode, the movement controls of the work machine are disabled.

### TECHNICAL FIELD

The present disclosure generally relates to a work machine, and more specifically, a work machine having a machine control with a safety mode for use in the construction industry.

### BACKGROUND

In construction, construction machines such as excavators and loader vehicles are typically utilized to remove earthen materials and load them onto trucks. In general, the truck backs into position near the excavator to be loaded with the earthen material excavated by the excavator. Sometimes, human workers are required to be near the construction machines to help guide the trucks and complete manual construction tasks near the operating construction machines. However, at night, in bad weather conditions, or from blind spots present on the construction machines, it can be difficult for operators of construction machines to see all human workers around the construction machine. This creates dangerous conditions where the human worker can become injured by the operating construction machines.

U.S. Pat. No. 11,028,553 discloses a construction machine having a distance sensor, a displacement detection and a position information acquisition unit. The distance sensor has a predetermined field of view and acquires distance image data indicating a distance distribution of an environment around the operator cab. The displacement detection unit compares comparative position information of the boom with initial position information of the boom to detect a displacement of the distance sensor with respect operator cab.

While effective, there remains a need for improved safety control for construction machines, such as construction machines in the construction industries.

### SUMMARY

In accordance with the present disclosure, a work machine is disclosed. The work machine has a machine control for controlling the movements of the work machine in an operating mode of the machine control. The work machine also has a processing unit that has a detection unit. The detection unit is located on the work machine and is used to detect a target object within a safety zone. The processing unit sends a detection signal to the machine control when the target object is detected within the safety zone, and the machine control enters a safety mode from the operating mode when the detection signal is received. In the safety mode, the movements of the work machine are disabled.

In accordance with another aspect of the present disclosure, a safety control system for a work machine is disclosed. The safety control system includes a machine control that controls the movements of the work machine, and the machine control includes a mode switching unit. The safety control system further has a processing unit that has a detection unit, and the detection unit is located on the work machine. The processing unit uses the detection unit to detect a target object in a safety zone, and upon detecting the target object, the processing unit sends a detection signal to the mode switching unit of the machine control. Upon receiving the detection signal, the mode switching unit switches the machine control from an operating mode to a safety mode, and the movements of the work machine are disabled in the safety mode.

In accordance with a further aspect of the present disclosure, a method of control of a safety-relevant mode of a work machine is provided. The method includes controlling the movements of the work machine with a machine control. The machine control provides full power to a motor and hydraulic system when the work machine control is in an operating mode, and the motor and hydraulic system moving the work machine based on inputs received at an operator control. The method further includes monitoring a safety zone with a processing unit of the work machine for detection of a target object in the safety zone. The processing unit has a detection unit that is located on the work machine. The processing unit sends a detection signal to the machine control when the target object is detected in the safety zone. The method then places the machine control into a safety mode when the detection signal is received at the machine control. The movement controls of the work machine are disabled after the machine control is placed into the safety mode.

These and other aspects and features of the present disclosure will be more readily understood when read in conjunction with the accompanying drawings.

### BRIEF DESCRIPTION OF THE DRAWINGS

FIG. 1 is a diagrammatic top down view of an exemplary work machine having a safety zone, in accordance with the present disclosure.

FIG. 2 is a front view of a target object, in accordance with the present disclosure.

FIG. 3 is a block diagram of a safety control system for the work machine, in accordance with the present disclosure.

FIG. 4 is a flow chart illustrating a method of the control of a safety-relevant mode of the work machine, in accordance with the present disclosure.

### DETAILED DESCRIPTION

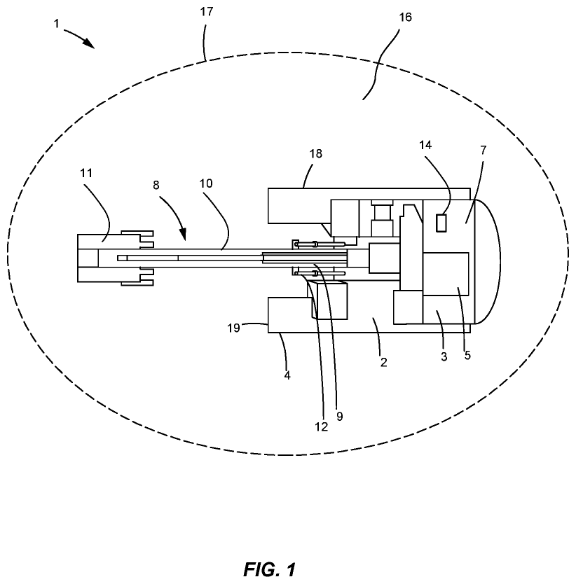

Referring to FIG. 1, a top down view of a work machine 1 is shown. The work machine 1 may embody a fixed or mobile machine that performs some type of operation associated with an industry such as construction, mining, farming, transportation, or other industries known to utilize heavy equipment. For example, the work machine 1 may be an earth moving machine such as an excavator, as shown, or a motor grader, backhoe, a dozer, a loader, a truck, or any other earth moving machine.

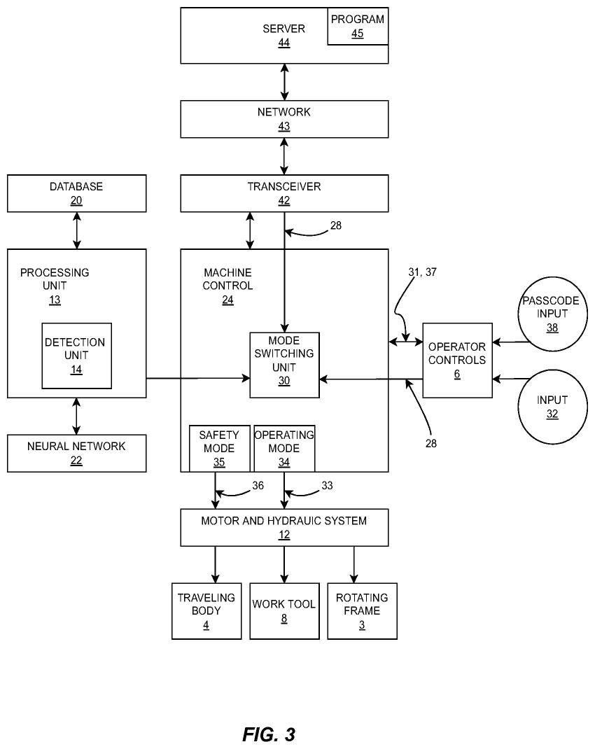

The work machine 1, as shown as a hydraulic excavator in the FIG. 1 exemplary embodiment, includes a base frame 2 that supports a rotating frame 3 that is slewably attached to the base frame 2, and the rotating frame 3 being up to 360 degrees rotatable relative to the base frame 2. The base frame 2 is supported on a crawler-type lower traveling body 4, but in another exemplary embodiment, the traveling body 4 may support wheels or other movement supporting means. An operator cab 5 containing the operator controls 6 (FIG. 3) necessary to operate the work machine 1 is mounted on the rotating frame 3.

The rotating frame 3 has a motor 7, and in the present exemplary embodiment, an internal combustion engine such as a diesel engine is used as the engine as a power generation device, but in another exemplary embodiment, another power generation device is used such as an electric motor, hybrid motor, or the like. The motor 7 is used to power the movements of the work machine, such as powering the traveling body 4 to move the work machine 1 on a ground surface.

A working tool 8, in the FIG. 1 exemplary embodiment, is attached to the rotating frame 3. Specifically, the working tool 8 is raisably and lowerably attached to the rotating frame 3, and includes a boom 9, an arm 10 that is pivotably attached to the distal end of the boom 9, and a bucket 11 that is pivotably attached to the distal end of the arm 10. The bucket 11 is able to dig or hold a predetermined held object, such as earthen material. The position of the boom 9, arm 10, and bucket 11 is controlled by a motor and hydraulic system 12, which includes the motor 7 and any hydraulic actuators, cylinders, and additional hydraulic motors (not shown) attached to the rotating frame 3, boom 9, arm 10, and bucket 11. More specifically, the motor and hydraulic system 12 is able to raise and lower the boom 9 that is pivotably attached to the rotating frame 3, raise and lower the arm 10 that is pivotably attached to the boom 9, and raise and lower the bucket 11 that is pivotably attached to the arm 10.

The work machine also has a processing unit 13 (FIG. 3) that includes a detection unit 14 that is disposed on the work machine 1. The detection unit 14 may include one camera, or sensor, or include one or more cameras, or sensors, placed around the work machine 1, and is capable of simultaneous monitoring a predetermined field of view (or detection range), and the detection range extending up to 360 degrees of the area around the work machine 1. The detection unit 14 may be one or more 2D cameras, 3D stereo camera, a LiDar camera, an ultrasonic distance sensing sensor, or a millimeter-wave radar, or may include a combination of two or more of any of these cameras/sensors.

In one exemplary embodiment, the processing unit 13 includes the detection unit 14 to detect a target object 15 within a safety zone 16 of the work machine 1. The safety zone 16 may be an area within a safety zone boundary 17, with the safety zone boundary surrounding the work machine 1, for example as shown in FIG. 1, encompassing all sides of the work machine 1. The safety zone boundary 17, in one exemplary embodiment, is a predetermined distance around the work machine 1, or may be determined by the detection range of the detection unit 14. The detection unit 14 is configured to detect the target object 15 after the target object has passed the safety zone boundary 17 and is within the safety zone 16. In another exemplary embodiment, the safety zone 16 is dynamic, and instead of surrounding the entire work machine 1 as shown in FIG. 1, the safety zone is the operational envelope of the work machine 1, and specifically the operational envelope of the rotating frame 3 or the working tool 8. In this example, the operating envelope of the rotating frame 3 or the work tool 8 would be all areas surrounding the rotating frame 3 and the work tool 8 that could be physically touched by rotating frame 3 and the work tool 8 as they are rotated, raised, or lowered to their physical maximum. Thus, for example, if the rotating frame 3 in the FIG. 1 embodiment was rotated 90 degrees to the right, the operating envelope of the work tool 8 would change to cover the work tool 8 on a right side 18 of the work machine 1 instead of a front side 19, however, the operation envelope of the rotating frame 3 would remain the same as it is still capable of rotating 360 degrees.

The detection unit 14, in one exemplary embodiment, is a two-dimensional (2D) imaging sensor such as one or more 2D cameras (imaging cameras) mounted on the work machine 1. In this embodiment, the two-dimensional imaging sensors are used to detect and identify surface characteristics of the target object 15 within a viewing field of the sensor. The 2D imaging cameras operate by projecting a wide light beam towards the safety zone 16 and collecting the reflected light reflected from the surfaces and objects (e.g., the target object 15) within the viewing area at a receiver. In another exemplary embodiment, the imaging cameras may sweep a light beam across the safety zone 16 in an oscillatory manner to collect line-wise image data, which is analyzed to identify the target object 15. For example, the detection unit 14 may continuously capture picture frames of the safety zone 16, and the processing unit 13 continuously process the captured picture frames by comparing the captured picture frames to known images of the target object stored on a database 20 (FIG. 3). The database 20 may be a hard drive that is operatively connected to the processing unit and located on the work machine 1, or may be a remote server that is wirelessly operatively connected to the processing unit. Upon detection of the target object 15 in the captured picture frames, the processing unit 13 sends a detection signal 21 (FIG. 3) to a machine control 24 (FIG. 3). In another embodiment, the processing unit 13 processes images captured by the detection unit 14 using a neural network 22 (FIG. 3) to determine if the target object 15 is present in the captured images, and upon detection of the target object 15 in the images the processing unit 13 sending the detection signal 21.

Alternatively, the detection unit 14 is a 2D camera that projects a stationary, substantially planar beam of light across the safety zone 16 and collects data on the objects that pass through the beam. In general, 2D image sensors perform grayscale or red-green-blue (RGB) analysis on the pixel data generated based on the reflected light to yield two-dimensional image data of the safety zone 16, or viewing field, which can be analyzed by the processing unit 13 to identify the target object 15. For example, the detection unit 14 uses a 2D to see wavelength light frequency, and the processing unit 13 processes the image data to detect a predetermined wavelength light frequency of the target object 15 to detect the target object 15.

In another exemplary embodiment, the detection unit 14 is a three-dimensional (3D) image sensor, also known as time-of-flight (TOF) sensors, that are designed to generate distance information as well as two-dimensional shape information for the target object 15 within the safety zone 16 (or viewing field). In one embodiment, the TOF sensors determine a distance of the target object 15 using phase shift monitoring techniques, where a beam of light is emitted in the safety zone 16, and the measured phase shift of light reflected from the target object 15 relative to the emitted light is translated to a distance value. In further embodiments, TOF sensors that employ pulsed light illumination measure the elapsed time between emission of a light pulse to the safety zone 16 and receipt of a reflected light pulse at the sensor's photo-receiver.

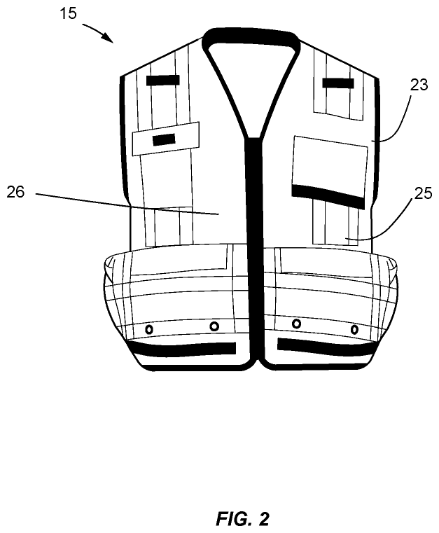

Turning back to FIG. 2, the target object 15, in the FIG. 2 embodiment, is a safety vest 23. The safety vest 15 is worn by a construction worker operating near the work machine 1. When the safety vest 23 passes the safety zone boundary 17 and into the safety zone 16, the processing unit 13 using the detection unit 14 detects the safety vest 23, and sends the detection signal 21 to the machine control 24. The detection unit 14 may detect the safety vest 14 by capturing images of a pattern 25, such as a stripped pattern using reflective tape or other predetermined pattern in the safety vest 23, or may detect a predetermined wavelength light frequency of a predetermined color 26 of the safety vest. In one exemplary embodiment, the color is a safety orange, but any predetermined color 26 can be preprogrammed by the processing unit to be the target object 15. In another exemplary embodiment, the target object 15 is not a safety vest 23, but is a different construction machine, clothing, or object having the predetermined pattern 25 or color 26 to be recognized as the target object 15 by the processing unit 13.

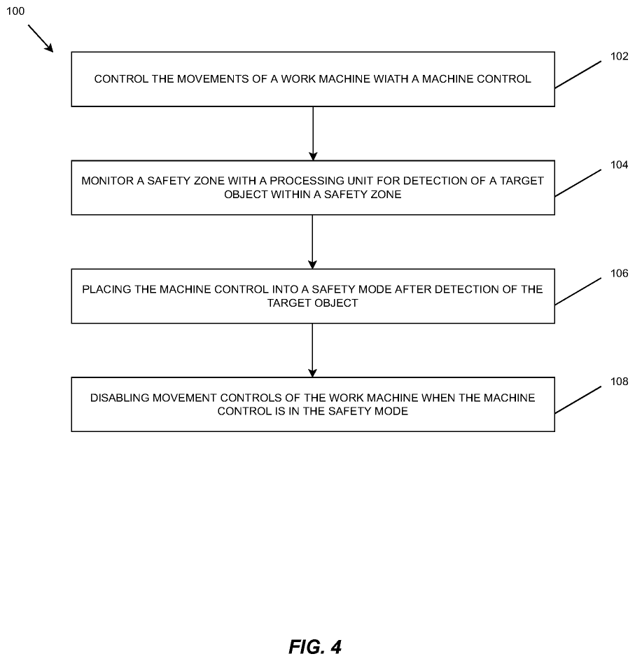

Turning to FIG. 4, a schematic block diagram of a safety control system 27 of the work machine 1 is shown. The safety control system 27 is designed to detect the target object 15 in the safety zone 16, and disable all machine movements, including the boom 9, arm 10, bucket 11, the traveling body 4, and the rotating frame 3. The safety control system 27 includes the machine control 24, the processing unit 13, and an override signal 28 received at a mode switching unit 30 of the machine control 24.

The machine control 24 is used to control the positioning of the working tool 8 (including the boom 9, arm 10, and bucket 11, or any working tool 8 of any construction machine), any rotating frame 3 of the work machine 3, and any traveling body 4 for positioning any work machine 1. To control these positionings, the machine control 24 first receives a movement signal 31 from the operator controls 6, located inside of the operator cab 5, based on an input 32 received at the operator controls 6 from an operator of the work machine 1. After receiving the movement signal 31, the machine control 24 sends an actuation signal 33 to the motor and hydraulic system 12. The motor and hydraulic system 12, upon receiving the actuation signal 33, then actuate the hydraulic cylinders and move the working tool 8. The motor 7 of the motor and hydraulic system 12, upon receiving the actuation signal, may be used to power the movements of the traveling body 4 and the rotating frame 3, or any other movements of the work machine 1 depending on the type of construction machine is used.

The machine control 24 defaults in an operating mode 34 in which full power from the motor and hydraulic system 12 is sent to the traveling body 4, work tool 8, and rotating body 3 to provide full speed movements of work machine 1. However, when the processing unit 13 detects the target object 15 in the safety zone 16, the processing unit sends the detection signal 21 to the machine control 24. Upon receipt of the detection signal 21, the machine control enters a safety mode 35. Once in the safety mode 35, the machine control 24 sends a disabling signal 36 to the motor and hydraulic system 12, and all movements, and the movement controls, of the work machine 1, including the traveling body 4, the work tool 8, and the rotating frame 3, are disabled, and no power is provided to the traveling body 4, the work tool 8, and the rotating frame 3 despite any inputs 32 received at the operator controls 6. Further, in the safety mode 35, the machine control sends a status signal 37 to the operator controls 6 indicating the machine controls of the work machine 1 are disabled, and the status signal is displayed on the operator controls 6 that the machine has entered the safety mode 35. This status signal may be text or symbol based, or a status signal displayed on a screen in the operator controls 6, or may include a status light that is illuminated. Additionally, in one exemplary embodiment, after entering the safety mode 35, if the target object 15 is no longer detected by the processing unit 13 in the safety zone 16, the safety mode 35 is disabled the machine control 24 returns to the operating mode 34, returning full movement controls and power to the motor and hydraulic system.

After entering the safety mode 35, in one embodiment, the safety mode 35 is disabled by entering in a passcode input 38 into the operator controls 6. Upon receiving the passcode input 38, the override signal 28 is sent from the operator controls 6 to the mode switching unit 30 of the machine control 24, and the machine control 24 switches from the safety mode 35 back into the operating mode 34. In one exemplary embodiment, the passcode input 38 may be a passcode entered by a maintenance worker, or the work machine 1 operator, into a display or keypad on the operator controls 6, or a maintenance panel on the work machine 1. Further, the passcode input 38 may be a keycard, key, or other input device (not shown) containing the passcode input 38 that is entered into the work machine 1.

Further, in another exemplary embodiment, the machine control 24 is operatively connected to a transceiver 42 located on the work machine 1. After entering into the safety mode 35, the machine control 24 enters into the operating mode 34 after receiving the override signal 28 from the transceiver 42. The override signal 28, prior to being received at the transceiver 42 is sent wirelessly over a network 43 from a computer server system 44. The computer server system 44 includes a work machine monitoring program 45 for receiving and monitoring diagnostic data about the work machine 1, including receiving an alert when the work machine 1 has entered into the safety mode 35.

### INDUSTRIAL APPLICABILITY

In general, the teachings of the present disclosure may find applicability in many industries including, but not limited to, construction machines or the like. More specifically, the teachings of the present disclosure may find applicability in any industry safety control systems of a work machine having a safety-relevant mode.

In accordance with the scope of the present disclosure, in one such operation it is desirable to enter a safety mode to disable a work machine when the presence of a construction worker is detected near the operating envelope of the work machine to prevent injury to the construction worker. However, sometimes equipment gets damaged and a false detection signal is sent to the machine control of the work machine, preventing the work machine from being able to disable the safety mode to move the work machine.

Turning now to FIG. 4, with continued reference to FIGS. 1-3, a flowchart illustrating an exemplary method 100 for control of at least-one safety-relevant mode of a work machine 1 is shown. At block 102, a machine control 24 controls the movements of a work machine 1, and provides full power to a motor and hydraulic system 12 when the machine control 24 is in an operating mode 34. The movements are based on inputs 32 received at an operating controls 6 of the work machine 1. At block 104, a safety zone 16 of the work machine 1 is monitored with a processing unit 13 for detection of a target object 15 within the safety zone 16. The processing unit 13 includes a detection unit 14 that is located on the work machine 1. The processing unit 13 sends a detection signal 21 to the machine control 24 when the target object 15 is detected in the safety zone 16. At block 106, and after receiving the detection signal 21, the machine control 24 is placed into a safety mode 35 from an operating mode 34. In the safety mode 35, the movement controls of the work machine 1 are disabled at block 108. The safety mode 35 may be overridden when an override signal 28 is received at the machine control 24, and the work machine 1 enters back into the operating mode 34.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

What is claimed is:

1. A work machine comprising:
a machine control that controls movements of the work machine, the machine control having an operating mode; and
a processing unit including a detection unit that is disposed on the work machine configured to detect a target object within a safety zone, in which the processing unit sends a detection signal to the machine control when the target object is detected within the safety zone, the machine control entering a safety mode from the operating mode when the detection signal is received at the machine control, and movement controls of the work machine are disabled in the safety mode.

2. The work machine of claim 1, in which the safety zone surrounds the work machine and is the operational envelope of the work machine.

3. The work machine of claim 2, in which the detection unit is one or more cameras disposed on the work machine that are configured to continuously monitor the safety zone, and the processing unit sending the detection signal upon detection of the object within the monitored safety zone.

4. The work machine of claim 3, in which the processing unit is operatively connected to a database, the detection unit continuously captures picture frames of the safety zone, the processing unit continuously processes the captured picture frames by comparing the captured picture frames to images of the target object stored on the database, and upon detection of the target object in the captured picture frames the processing unit sending the detection signal.

5. The work machine of claim 3, in which the processing unit processes images captured by the detection unit using a neural network to determine if the target object is present in the images, and upon detection of the target object in the images the processing unit sending the detection signal.

6. The work machine of claim 1, in which the target object has a predetermined pattern or predetermined color, and the target object is detected by the predetermined pattern or predetermined color.

7. The work machine of claim 6, in which the target object is a safety vest having the predetermined pattern or predetermined color.

8. The work machine of claim 1, in which the safety zone is adaptive and surrounds the operational envelope of a work tool attached to a frame of the work machine.

9. The work machine of claim 1, in which after entering the safety mode, if the target object is no longer detected within the safety zone, the safety mode is disabled and the movement of the work machine is reenabled.

10. The work machine of claim 1, in which after entering the safety mode, the machine control displaying on an operator control of the work machine an indication that the machine control has entered the safety mode.

11. The work machine of claim 1, in which after entering the safety mode, the safety mode is configured to be disabled through a passcode received at an operator control of the work machine.

12. The work machine of claim 1, in which after entering the safety mode, the machine control entering back into the operating mode upon receiving a passcode at an operator control of the work machine.

13. The work machine of claim 1, in which the machine control is operatively connected to a transceiver, and after entering the safety mode the machine control is configured to enter back into the operating mode upon receiving an override signal at the transceiver.

14. The work machine of claim 13, in which the transceiver is in operative connection with a server having a work machine monitoring program.

15. A safety control system for a work machine, comprising:
a machine control that controls movements of the work machine, the machine control having a mode switching unit;
a processing unit including a detection unit that is disposed on the work machine configured to detect a target object within a safety zone, in which the processing unit sends a detection signal to the mode switching unit of the machine control when the target object is detected within the safety zone, the mode switching unit switching the machine control from an operating mode to a safety mode when the detection signal is received, and movement controls of the work machine are disabled in the safety mode; and
an override signal received at the mode switching unit, the mode switching unit switching the machine control from the safety mode back into the operating mode when the override signal is received.

16. The safety control system of claim 15, in which the override signal is sent from an operator control of the work machine to the mode switching unit upon receiving a predetermined input on the operator control.

17. The safety control system of claim 15, in which the machine control is operatively connected to a transceiver, and the override signal is wirelessly sent to the transceiver from a computer server system.

18. The safety control system of claim 17, in which the computer server system includes a work machine monitoring program for monitoring diagnostic data about the work machine.

19. The safety control system of claim 15, in which after entering the safety mode the machine control displaying on an operator control of the work machine an indication that the machine control has entered the safety mode.

20. A method for the control of at least one safety-relevant mode of a work machine, comprising:
controlling the movements of the work machine with a machine control, the machine control providing full power to a motor and hydraulic system when the machine control is in an operating mode, the motor and hydraulic system providing the movements of the work machine based on an input at an operator control of the work machine;
monitoring a safety zone with a processing unit of the work machine for detection of a target object within the safety zone, the processing unit including a detection unit that is disposed on the work machine, the processing unit sending a detection signal to the machine control when the target object is detected with in the safety zone;
placing the machine control into a safety mode upon receiving the detection signal at the machine control; and
disabling movement controls of the work machine when the machine control is placed into the safety mode.
